(19) United States
(12) Patent Application Publication
(10) Pub. No.: US 2022/0363854 A1
(43) Pub. Date: Nov. 17, 2022

(54) METHODS AND COMPOSITIONS FOR PRODUCING GRAPHENE POLYURETHANE FOAMS

(71) Applicant: Universal Matter Inc., Burlington (CA)

(72) Inventor: Vladimir Mancevski, Austin, TX (US)

(21) Appl. No.: 17/771,360

(22) PCT Filed: Oct. 26, 2020
(86) PCT No.: PCT/CA2020/051434

§ 371 Date: Apr. 22, 2022

Related U.S. Application Data
(60) Provisional application No. 62/925,317, filed on Oct. 24, 2019.

(51) Int. Cl. C08J 9/00; C01B 32/194; C08G 18/76; C08G 18/36

(52) U.S. Cl. CPC C08J 9/0066; C01B 32/194; C08G 18/7671; C08G 18/36; C08J 2375/04; C08J 2207/02

(57) ABSTRACT

Provided herein is a method of producing a polyurethane foam. The method includes dispersing turbostratic graphene in a polymerization solution. The polymerization solution includes a first component for polymerization into a polymer. The method includes adding a second component for polymerizing with the first component to chemically convert the polymerization solution into a polyurethane foam. Provided herein is also a polyurethane foam which includes a turbostratic graphene and a polymer formed from the polymerization of a polyol with an isocyanate. Provided herein is also a turbostratic graphene dispersion which includes a turbostratic graphene and a solvent for dispersing the turbostratic graphene.

### TECHNICAL FIELD

The embodiments disclosed herein relate to polyurethane foams and, in particular to compositions and methods of producing graphene polyurethane foams.

### INTRODUCTION

Polyurethane foams are used in a variety of applications. Adding graphene to the components for making a polyurethane foam may provide various advantages. However, graphene dispersions in the components may not be able to have high concentrations of conventional graphene. Turbostratic graphene provides various advantages over conventional graphene due to its turbostratic nature. For example, turbostratic graphene possesses fewer layers of graphene compared to conventional graphene which allows for higher concentrations of graphene in graphene dispersions.

Further, turbostratic graphene dispersions could not previously be produced in high concentrations due to the low yields of graphene produced by chemical methods. However turbostratic graphene can be produced in bulk quantities by joule heating a carbon feedstock.

Accordingly, there is a need for new methods of producing polyurethane foams and new polyurethane foams which include turbostratic graphene. Further, there is a need for turbostratic graphene dispersions which can be used for producing polyurethane foams. There is also a need for high concentration turbostratic graphene dispersions which can be used as master batches to allow for increased ease of storage of the dispersion.

### SUMMARY

According to some embodiments, there is a method of producing a polyurethane foam. The method includes dispersing turbostratic graphene in a polymerization solution. The polymerization solution includes a first component for polymerization into a polymer. The method also includes adding a second component for polymerizing with the first component to chemically convert the polymerization solution into a polyurethane foam.

The method may provide that the first component is a monomer or a polymer.

The method may provide that the second component is a monomer or a polymer.

The method may provide that the turbostratic graphene is dispersed in the polymerization solution by at least one of the group comprising ultrasonication, shear mixing, stirring, shaking, vortex shaking, milling, ball milling, and grinding.

The method may provide that the first component is a polyol and the second component is an isocyanate.

The method may provide that the polyol is at least one of the group comprising a petroleum-based polyol and a bio-based polyol.

The method may provide that the petroleum-based polyol is produced from at least one of the group comprising mineral oil, paraffinic oil, naphthenic oil, crude oil, kerosene, aliphatic oil, aromatic oil, coal oil, diesel oil, motor oil, and turbine oil.

The method may provide that the bio-based polyol is produced from at least one of the group comprising vegetable oil, seed oil, soy bean oil, rapeseed oil, canola oil, peanut oil, cotton seed oil, sunflower oil, olive oil, grape seed oil, linseed oil, castor oil, fish oil, algal oil, and mustard seed oil.

The method may provide that the isocyanate is at least one of the group comprising methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), and tolidine diisocyanate (TODI).

The method may also include dispersing the turbostratic graphene into a solvent prior to dispersing into the polymerization solution.

The method may also include heating the solvent while dispersing the turbostratic graphene into the solvent.

The method may provide that the solvent includes at least one of the group comprising a water-based solvent, an alcohol-based solvent, an organic solvent, and an oil-based solvent.

The method may provide that the water-based solvent is water-surfactant solution.

The method of claim 12, wherein the water-based solvent is at least one of the group comprising sodium dodecyl sulfate (SDS), sodium dodecylbenzenesulfonate (SDBS), lithium dodecyl sulfate (LDS), sodium deoxycholate (DOC), sodium taurodeoxycholate (TDOC), cetyltrimethylammonium bromide (CTAB), tetradecyltrimethylammonium bromide (TTAB), pluronic F87, polyvinylpyrrolidone (PVP), polyoxyethylene (40) nonylphenylether (CO-890), Triton X-100, Tween 20, Tween 80, polycarboylate (H14N), sodium cholate, tetracyanoquinodimethane (TCNQ), pyridinium tribromide, N,N′-dimethyl-2,9-diazaperopyrenium dication, N,N′-dimethyl-2,7-diazapyrene, tetrasodium 1,3,6,8-pyrenetetrasulfonate, 1-pyrenemethylamine hydrochloride, 1,3,6,8-pyrenetetrasulfonic acid tetrasodium salt hydrate, 1-pyrenecarboxylic acid, 1-aminopyrene, 1-aminomethyl pyrene, 1-pyrenecarboxylic acid, 1-pyrenebutyric acid, 1-pyrenebutanol, 1-pyrenesulfonic acid hydrate, 1-pyrenesulfonic acid sodium salt, 1,3,6,8-pyrenetetrasulfonic tetra acid tetra sodium salt, 6,8-dihydroxy-1,3-pyrenedisulfonic acid disodium salt, 8-hydroxypyrene-1,3,6-trisulfonic acid trisodium salt, perylenebisimide bolaamphiphile, tetrabutyl ammonium hydroxide (TBA), 9-anthracene carboxylic acid.

The method may provide that the water-based solvent is at least one of the group comprising a water-surfactant solution, a water-pluronic solution, and a water-dihydrolevoglucosenone solution.

The method may provide that the alcohol-based solvent is at least one of the group comprising methanol ethyl alcohol, isopropyl alcohol, butanol, pentanol, ethylene glycol, propylene glycol and glycerol.

The method may provide that the organic solvent is at least one of the group comprising toluene, N-methyl-2-pyrrolidone (NMP), xylene, benzene, 1,2-dichlorobenzene (DCB), and dimethylformamide (DMF).

The method may provide that the organic solvent is at least one of the group comprising seed oil, soy bean oil, rapeseed oil, canola oil, peanut oil, cotton seed oil, sunflower oil, olive oil, grape seed oil, linseed oil, castor oil, fish oils, algal oils, mustard seed oils.

The method may provide that the concentration of turbostratic graphene dispersed in the solvent is between 1-15 mg/mL.

The method may provide that the turbostratic graphene has graphene layers which are misoriented in respect to each other.

The method may provide that the turbostratic graphene has a surface area of between 200 and 300 m²/g.

The method may provide that the turbostratic graphene has between 1 to 5 layers of graphene.

The method may provide that the turbostratic graphene has a particle diameter between 5nm to 2000 nm.

The method may provide that the turbostratic graphene has an oxygen content of between 0.1% to 5% by atomic proportion.

The method may also include heating the polymerization solution while dispersing the turbostratic graphene.

A turbostratic graphene polyurethane foam may be produced by the method.

According to some embodiments there is a polyurethane foam which includes a turbostratic graphene. The polyurethane foam also includes a polymer formed from the polymerization of a polyol with an isocyanate.

The polyurethane foam may provide that the turbostratic graphene increases compressive strength of the polyurethane foam relative to a polyurethane foam without turbostratic graphene.

The polyurethane foam may provide that the turbostratic graphene decreases average pore size of the polyurethane foam relative to a polyurethane foam without turbostratic graphene.

The polyurethane foam may provide that the turbostratic graphene increases thermal insulation of the polyurethane foam relative to a polyurethane foam without turbostratic graphene.

The polyurethane foam may provide that the turbostratic graphene increases thermal insulation of the polyurethane foam by at least 60%.

The polyurethane foam may provide that the turbostratic graphene increases sound absorption of the polyurethane foam relative to a polyurethane foam without turbostratic graphene.

The polyurethane foam may provide that the polyurethane foam has a density between 20-95 kg/m³.

The polyurethane foam may provide that the turbostratic graphene has graphene layers which are misoriented in respect to each other.

The polyurethane foam may provide that the turbostratic graphene has a surface area of between 200 and 300 m²/g.

The polyurethane foam may provide that the turbostratic graphene has between 1 to 5 layers of graphene.

The polyurethane foam may provide that the turbostratic graphene has a particle diameter between 5nm to 2000 nm.

The polyurethane foam may provide that the turbostratic graphene has an oxygen content of between 0.1% to 5% by atomic proportion.

The polyurethane foam may provide that the turbostratic graphene is produced from from at least one of the group comprising petroleum coke, tire carbon black, carbon black, metallurgical coke, plastic ash, plastic powder, ground coffee, anthracite coal, coal, corn starch, pine bark, polyethylene microwax, wax, chemplex 690, cellulose, naptenic oil, asphaltenes, gilsonite, and carbon nanotubes.

The polyurethane foam may provide that the turbostratic graphene is produced by joule heating a carbon powder.

The polyurethane foam may provide that the turbostratic graphene is produced by joule heating a carbon-based pill.

The polyurethane foam may provide that the turbostratic graphene is produced from a carbon feedstock by joule heating the carbon feedstock to a temperature between 2800° C. to 3000° C.

The polyurethane foam may provide that the polyol is at least one of the group comprising a petroleum-based polyol and a bio-based polyol.

The polyurethane foam may provide that the isocyanate is at least one of the group comprising methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), and tolidine diisocyanate (TODD.

The polyurethane foam may be used in an automotive seat, a bedding, a furniture, a flooring, a road fill, or building construction.

The polyurethane foam may be used as a urethane coating, an adhesive, a sealant, an epoxy, or an elastomer.

According to some embodiments there is a kit for producing a polyurethane foam which includes a turbostratic graphene. The kit also includes a polymerization solution for conversion into a polyurethane foam. The polymerization solution includes a first component for polymerization into a polymer.

The kit may also include a second component for polymerizing with the first component.

The kit may provide that the first component is a monomer or a polymer.

The kit may provide that the second component is a monomer or a polymer.

The kit may provide that the first component is a polyol and the second component is an isocyanate.

The kit may provide that the polyol is at least one of the group comprising a petroleum-based polyol and a bio-based polyol.

A turbostratic graphene polyurethane foam may be produced by the kit.

According to some embodiments, there is a turbostratic graphene dispersion which includes a turbostratic graphene. The turbostratic graphene dispersion also includes a solvent for dispersing the turbostratic graphene.

The turbostratic graphene dispersion may provide that the turbostratic graphene concentration in the solvent is between 1 mg/mL and 15 mg/mL.

The turbostratic graphene dispersion may provide that the turbostratic graphene has graphene layers which are misoriented in respect to each other.

The turbostratic graphene dispersion may provide that the turbostratic graphene is a graphene that has 5 or fewer layers.

The turbostratic graphene dispersion may provide that the solvent for dispersing the turbostratic graphene is a polyol solution for conversion into a polyurethane foam.

The turbostratic graphene dispersion may provide that the solvent for dispersing the turbostratic graphene is an isocyanate solution for conversion into a polyurethane foam.

The turbostratic graphene dispersion may provide that the solvent for dispersing the turbostratic graphene is at least one of the group comprising a water-based solvent, an alcohol-based solvent, an organic solvent, and an oil-based solvent.

The turbostratic graphene dispersion may provide that the water-based solvent is a water-surfactant solution.

The turbostratic graphene dispersion may provide that the concentration of turbostratic graphene on the water-based solvent is between 1 to 5 mg/mL.

The turbostratic graphene dispersion may provide that the water-based solvent is at least one of the group comprising a water-surfactant solution, a water-pluronic solution, and a water-dihydrolevoglucosenone solution.

The turbostratic graphene dispersion may provide that the water-based solvent is at least one of the group comprising sodium dodecyl sulfate (SDS), sodium dodecylbenzenesulfonate (SDBS), lithium dodecyl sulfate (LDS), sodium deoxycholate (DOC), sodium taurodeoxycholate (TDOC), cetyltrimethylammonium bromide (CTAB), tetradecyltrimethylammonium bromide (TTAB), pluronic F87, polyvinylpyrrolidone (PVP), polyoxyethylene (40) nonylphenylether (CO-890), Triton X-100, Tween 20, Tween 80, polycarboylate (H14N), sodium cholate, tetracyanoquinodimethane (TCNQ), pyridinium tribromide, N,N′-dimethyl-2,9-diazaperopyrenium dication, N,N′-dimethyl-2,7-diazapyrene, tetrasodium 1,3,6,8-pyrenetetrasulfonate, 1-pyrenemethylamine hydrochloride, 1,3,6,8-pyrenetetrasulfonic acid tetrasodium salt hydrate, 1-pyrenecarboxylic acid, 1-aminopyrene, 1-aminomethyl pyrene, 1-pyrenecarboxylic acid, 1-pyrenebutyric acid, 1-pyrenebutanol, 1-pyrenesulfonic acid hydrate, 1-pyrenesulfonic acid sodium salt, 1,3,6,8-pyrenetetrasulfonic tetra acid tetra sodium salt, 6,8-dihydroxy-1,3-pyrenedisulfonic acid disodium salt, 8-hydroxypyrene-1,3,6-trisulfonic acid trisodium salt, perylenebisimide bolaamphiphile, tetrabutyl ammonium hydroxide (TBA), 9-anthracene carboxylic acid

The turbostratic graphene dispersion may provide that the alcohol-based solvent is at least one of the group comprising methanol ethyl alcohol, isopropyl alcohol, butanol, pentanol, ethylene glycol, propylene glycol and glycerol.

The turbostratic graphene dispersion may provide that the concentration of turbostratic graphene on the alcohol-based solvent is between 1 to 50 mg/mL.

The turbostratic graphene dispersion may provide that the concentration of turbostratic graphene on the alcohol-based solvent is 6.3% w/w or less.

The turbostratic graphene dispersion may provide that the organic solvent is at least one of the group comprising acetone, toluene, N-methyl-2-pyrrolidone (NMP), xylene, benzene, 1,2-dichlorobenzene (DCB), dimethylformamide (DMF), and methyl ethyl ketone (MEK).

The turbostratic graphene dispersion may provide that the concentration of turbostratic graphene on the organic solvent is between 1 to 100 mg/mL.

The turbostratic graphene dispersion may provide that the concentration of turbostratic graphene on the organic solvent is 11% w/w or less.

The turbostratic graphene dispersion may provide that the oil-based solvent is at least one of the group comprising vegetable oil, seed oil, soy bean oil, rapeseed oil, canola oil, peanut oil, cotton seed oil, sunflower oil, olive oil, grape seed oil, linseed oil, castor oil, fish oil, algal oil, mustard seed oil, mineral oil, and naphthenic oil.

The turbostratic graphene dispersion may provide that the concentration of turbostratic graphene on the oil-based solvent is between 1 to 100 mg/mL.

The turbostratic graphene dispersion may provide that the concentration of turbostratic graphene on the oil-based solvent is 11% w/w or less.

The turbostratic graphene dispersion may provide that the turbostratic graphene dispersion is a master batch which is between 5 to 10 times more concentrated than a concentration necessary for producing a polyurethane foam

The turbostratic graphene dispersion may provide that the solvent is a polyol.

The turbostratic graphene dispersion may provide that the polyol is heated while dispersing the graphene.

The turbostratic graphene dispersion may provide that the polyol is stirred while dispersing the graphene.

The turbostratic graphene dispersion may provide that the solvent is an isocyanate.

According to some embodiments there is a polyurethane foam which includes a graphene. The polyurethane foam also includes a polymer formed from the polymerization of a polyol with an isocyanate, wherein the polyol is produced from an oil.

The polyurethane foam may provide that the graphene is at least one of the group comprising a turbostratic graphene, a very few layer graphene, a few layer graphene, a multilayer graphene, and a graphene nanoplatelet.

The polyurethane foam may provide that the turbostratic graphene has graphene layers which are misoriented in respect to each other.

The polyurethane foam may provide that the turbostratic graphene has a surface area of between 200 and 300 m²/g.

The polyurethane foam may provide that the turbostratic graphene has between 1 to 5 layers of graphene.

The polyurethane foam may provide that the turbostratic graphene has a particle diameter between 5nm to 2000 nm.

The polyurethane foam may provide that the polyol is produced from at least one of the group comprising a petroleum-based oil and a bio-based oil.

The polyurethane foam may provide that the petroleum-based oil is at least one of the group comprising mineral oil, paraffinic oil, naphthenic oil, crude oil, kerosene, aliphatic oil, aromatic oil, coal oil, diesel oil, motor oil, and turbine oil.

The polyurethane foam may provide that the bio-based oil is at least one of the group comprising vegetable oil, seed oil, soy bean oil, rapeseed oil, canola oil, peanut oil, cotton seed oil, sunflower oil, olive oil, grape seed oil, linseed oil, castor oil, fish oil, algal oil, and mustard seed oil.

The polyurethane foam may provide that the isocyanate is at least one of the group comprising methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), and tolidine diisocyanate (TODI).

According to some embodiments there is a method of producing a polyurethane foam. The method includes dispersing a graphene in an oil. The method also includes chemically converting the oil into a polyol. The method also includes adding an isocyanate to chemically convert the polyol into a polyurethane foam.

The method may provide that the graphene is at least one of the group comprising a turbostratic graphene, a very few layer graphene, a few layer graphene, a multilayer graphene, and a graphene nanoplatelet.

The method may provide that the turbostratic graphene has graphene layers which are misoriented in respect to each other.

The method may provide that the turbostratic graphene has a surface area of between 200 and 300 m²/g.

The method may provide that the turbostratic graphene has between 1 to 5 layers of graphene.

The method may provide that the turbostratic graphene has a particle diameter between 5 nm to 2000 nm.

The method may provide that the polyol is produced from at least one of the group comprising a petroleum-based oil and a bio-based oil.

The method may provide that the petroleum-based oil is at least one of the group comprising mineral oil, paraffinic oil, naphthenic oil, crude oil, kerosene, aliphatic oil, aromatic oil, coal oil, diesel oil, motor oil, and turbine oil.

The method may provide that the bio-based oil is at least one of the group comprising vegetable oil, seed oil, soy bean oil, rapeseed oil, canola oil, peanut oil, cotton seed oil, sunflower oil, olive oil, grape seed oil, linseed oil, castor oil, fish oil, algal oil, and mustard seed oil.

The method may provide that the isocyanate is at least one of the group comprising methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), and tolidine diisocyanate (TODI).

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A a transmission electron microscopy (TEM) image of turbostratic graphene, according to an embodiment.

FIG. 1B is a high resolution TEM image of turbostratic graphene is shown. The high resolution image demonstrates regions 105 where 3-4 layers of graphene or more are detected superimposed on a flat sheet, according to an embodiment.

FIG. 1C is a high resolution transmission electron microscopy (HRTEM) of a turbostratic graphene, according to an embodiment.

FIG. 1D is a representative selected area electron diffraction (SAED) of the structure presented in FIG. 1C showing the turbostratic nature of the graphene, according to an embodiment.

FIG. 1E is the intensity profile of the SAED in FIG. 1D, according to an embodiment.

FIG. 1F is an X-ray photoelectron spectroscopy (XPS) spectra of a representative sample of turbostratic graphene produced by joule heating, according to an embodiment.

FIG. 2A is a flowchart demonstrating a method of producing a polyurethane foam (PUF).

FIG. 2B is a comparison of the physical properties of turbostratic graphene based PUF composite (TGPU) to a PUF composite having conventional graphene (XGPU), the relative change is shown with respect to PUF without any additives (Standard PU).

FIG. 3 is images of the foam pore sizes as a function of additive material, according to an embodiment.

FIG. 4 is images of a polyurethane foams of Batch H are shown before and after compression with a 100 g load, according to an embodiment. PUF without any additives is shown before 405 and after compression.

FIG. 5 is a graph showing the thermal conductivity of the four polyurethane foams, according to an embodiment.

FIG. 6 is images of an apparatus for measuring the sound absorption characteristics of the four polyurethane foams, according to an embodiment.

FIG. 7 is a turbostratic graphene-oil dispersion before and after three weeks of storage, according to an embodiment.

FIG. 8 is a flowchart demonstrating a method of producing a polyurethane foam.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The term “graphene” refers to a material which is a one-atom-thick planar sheet of sp²-bonded carbon atoms that are densely packed in a honeycomb crystal lattice, and, further, contains an intact ring structure of carbon atoms and aromatic bonds throughout at least a majority of the interior sheet and lacks significant oxidation modification of the carbon atoms. Graphene is distinguishable from graphene oxide in that it has a lower degree of oxygen containing groups such as OH, COOH and epoxide. The term “a graphene monolayer” refers to graphene that is a single layer of graphene. The term “a very few layer graphene” refers to a graphene that is between 1 to 3 layers of graphene. The term “a few layer graphene” refers to a graphene that is between 2 to 5 layers of graphene. The term “a multilayer graphene” refers to a graphene that is between 2 to 10 layers of graphene.

The term “turbostratic graphene” refers to to a graphene that has little order between the graphene layers. Other terms which may be used include misoriented, twisted, rotated, rotationally faulted, and weakly coupled. The rotational stacking of turbostratic graphene helps mitigate interlayer coupling and increases interplanar spacing, thereby yielding superior physical properties relative to competitive graphene structures when compared on a similar weight basis. The subtle difference in adjacent layer stacking orientation expresses itself with important differences in product performance attributes. An important performance benefit evident with turbostratic graphene is that multi-layer graphene structures separate into few and individual graphene layers more easily and the graphene layers tend not to recouple. The turbostratic nature of a graphene may be observed and confirmed by Raman spectroscopy, Transmission Electron Microscopy (TEM), selected area electron diffraction (SAED), scanning transmission electron microscopy (STEM), and X-ray diffraction (XRD) analysis.

One method of producing bulk turbostratic graphene is by joule heating a carbon powder or a carbon-based pill. Turbostratic graphene may be produced from a carbon pill by joule heating at temperatures of 2800 to 3000 C. The synthesis of graphene from a carbon pill generates predominantly few-layer turbostratic graphene. The turbostratic graphene is graphene layers which are misorient with respect to each other. The graphene layers are therefore not A-B stacked are misoriented with respect to each other. The graphene layer configuration of turbostratic graphene allows for easier dispersion of the graphene powder in liquids. Easier dispersion of graphene enables fabrication of better graphene composites.

A joule heating synthesis method and compositions thereof are described in Patent Cooperation Treaty Application having International Publication Number WO 2020/051000 A1 to Tour et al., having an interntional publication date of Mar. 12, 2020, which is herein incorporated by reference in its entirety.

The graphene layers of turbostratic graphene are randomly stacked instead of the A-B stacked graphene found with other types of bulk graphene. The turbostratic nature of the disclosed graphene makes it easier to disperse in higher concentrations and to remain dispersed for long periods of time such as periods of days to years. The turbostratic graphene may be dispersed in concentrations of 1 mg/mL (1 g/L) to 15 mg/mL (15 g/L), depending on the media. In contrast, conventional graphene may only be dispersed up to 1 mg/mL (1 g/L). Turbostratic graphene dispersions may be used for making a turbostratic graphene polyurethane foam (TGPUF). For example, a turbostratic graphene distribution in water, oil, or polyol may be used for making TGPUF. In some embodiments the turbostratic graphene is dispersed directly in the media and in some embodiments a second additive media is used to aid the turbostratic graphene dispersion.

Turbostratic graphene may have a surface area between 100 to 300 m²/g, as compared to conventional graphene which is between 120 to 150 m²/g.

Turbostratic graphene may have a particle or grain size between 5 nm to several microns, as compared to conventional graphene, which has a particle diameter of 4 to 6 microns.

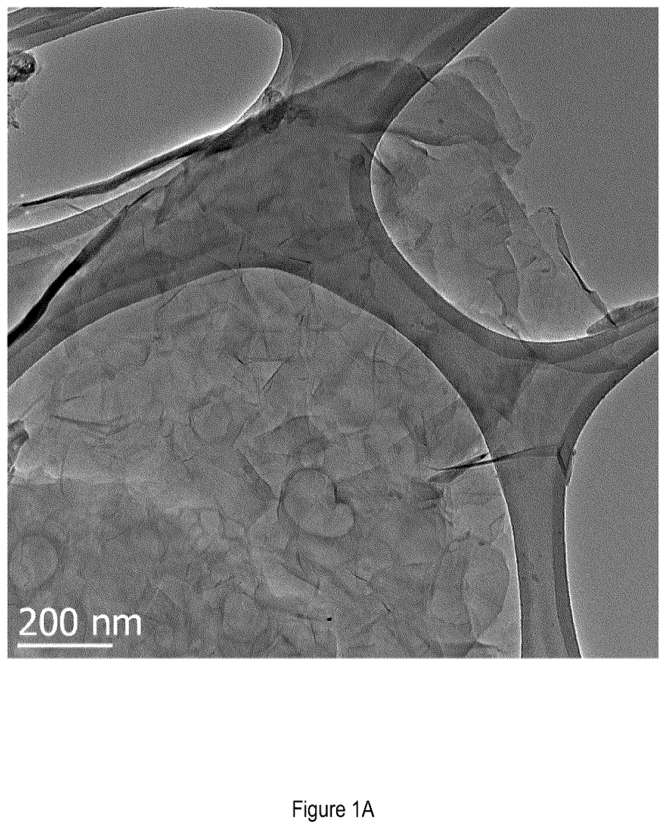

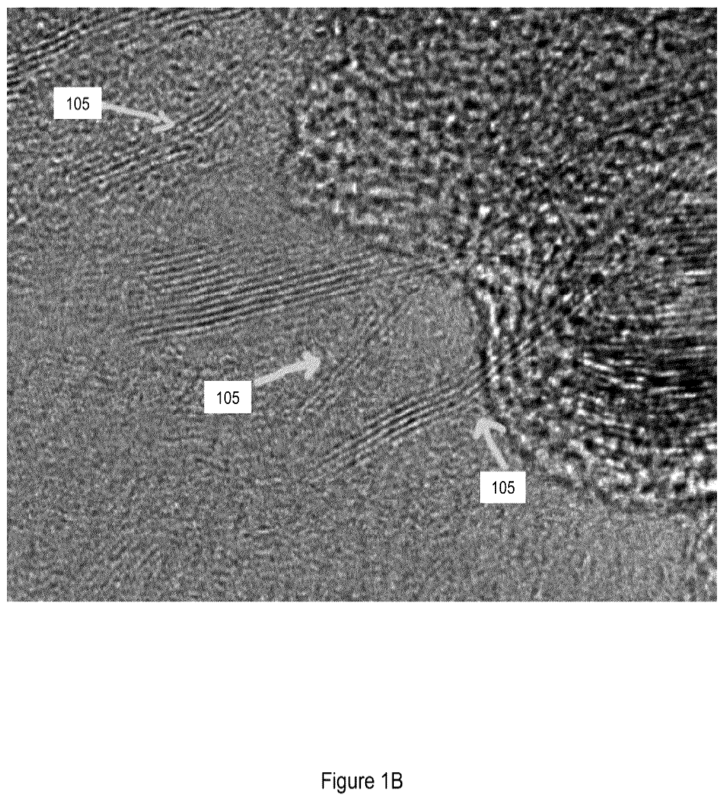

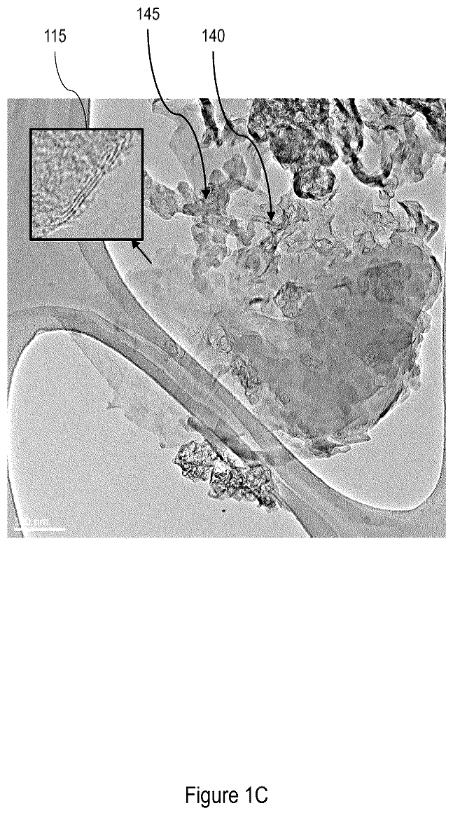

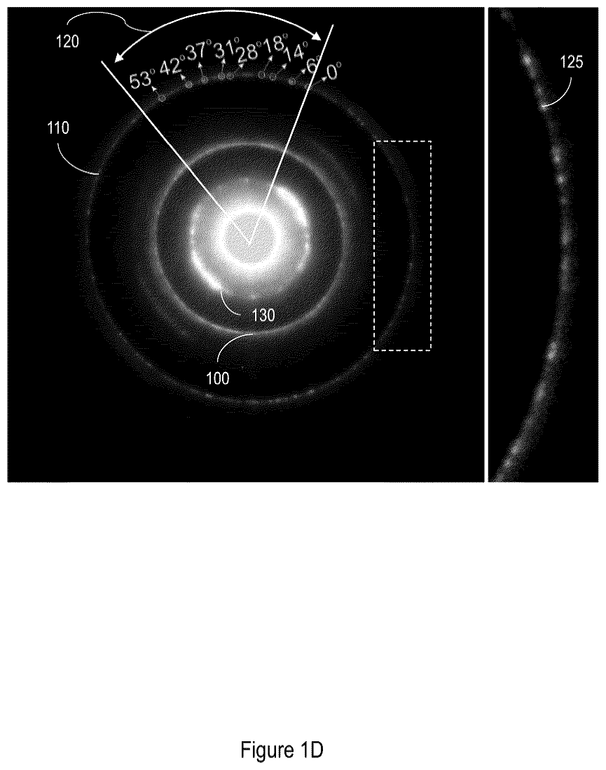

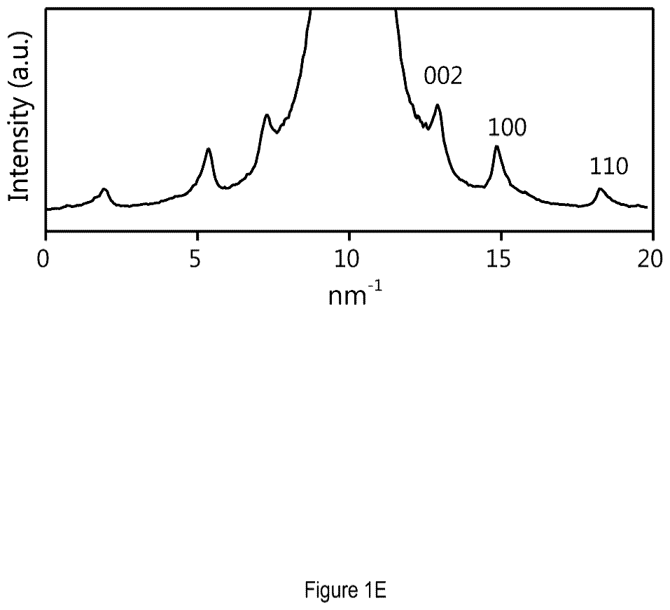

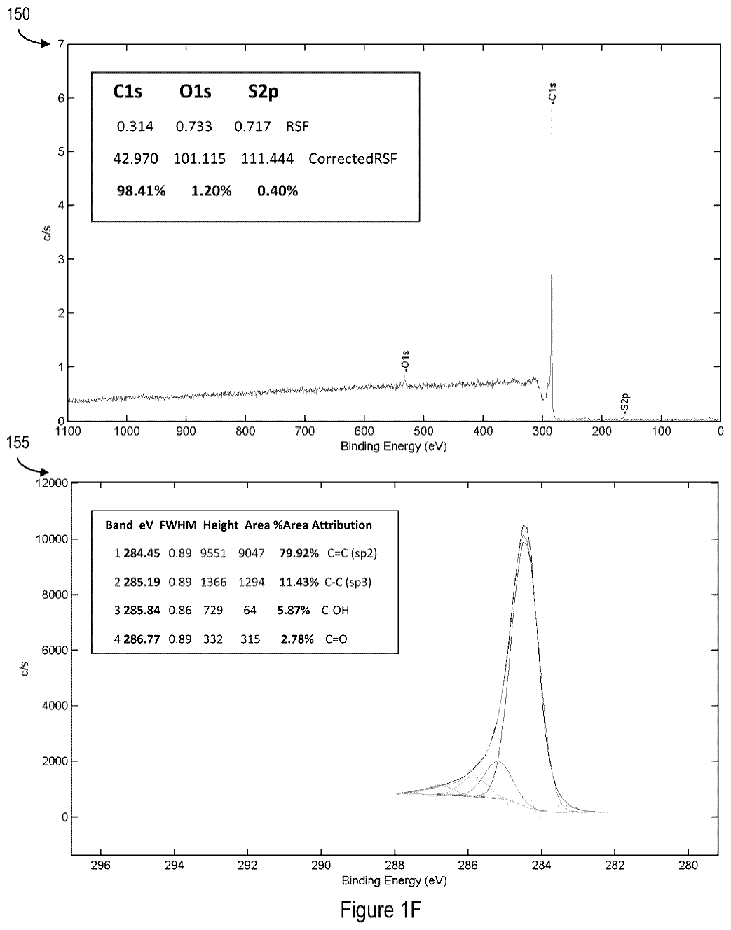

Referring to FIG. 1A, illustrated therein is a transmission electron microscopy (TEM) image of turbostratic graphene, according to an embodiment. A 200 nm scale bar is shown on the bottom left of the image to demonstrate the scale of the image. Referring to FIG. 1B, illustrated therein is a high resolution TEM image of turbostratic graphene is shown. The high resolution image demonstrates regions 105 where 3-4 layers of graphene or more are detected superimposed on a flat sheet, according to an embodiment.

Turbostratic graphene has between 1 to 5 graphene layers which are not A-B stacked, as illustrated on FIGS. 1A and 1B. In contrast, conventional graphene has more than 5 A-B stacked graphene layers, typically more than 10 A-B stacked graphene layers. The energy to exfoliate A-B stacked graphite or graphene into few layer graphene is much higher than for turbostratic grpahene. A-B stacked graphite or graphene for example can be exfoliated using high energy sonication and using harsh chemical methods. Due to the larger number of A-B stacked graphene layers, conventional graphene is harder to disperse in higher concentrations and their composites weigh more per unit volume because much of the graphene sandwiched between the outer layers does not participate in the composite enhancement.

Referring to FIG. 1C, illustrated therein is a high resolution transmission electron microscopy (HRTEM) of a turbostratic graphene made from a pill, according to an embodiment. The inset image 115 shows a high magnification image of the sheet edge displaying three graphene planes.

A method of synthesizing graphene by joule heating a carbon pill and compositions thereof are described in Patent Cooperation Treaty Application having International Application Number PCT/CA2020/051368 to Mancevski, having an interntional application date of Oct. 13, 2020, which is herein incorporated by reference in its entirety.

Referring to FIG. 1D, illustrated therein is a representative selected area electron diffraction (SAED) of the structure presented in FIG. 1C showing the turbostratic nature of the graphene, according to an embodiment. Arc 110 is observed as a ring superimposed with distinct bright spots. Each circled spot in the arc 110 within a 60-degree arc 120 represents individual sub-stack or sheets with different angle orientation (up to 53°) relative to the reference placed at right of the arc (0° spot). Dashed box over the SAED pattern is magnified on the right side of FIG. 1D, showing the contribution of each individual spot 125.

Referring to FIG. 1E, illustrated therein is the intensity profile of the SAED in FIG. 1D, according to an embodiment. The distance of plane 130 is shown to be 0.35 nm, plane 100 is shown to be 0.21 nm, and plane 110 is 0.12 nm. The distances are calibrated against an aluminum metal SAED reference.

The high purity of graphene and low oxygen content of turbostratic graphene means that the composite that is made with turbostratic graphene may have less defects and impurities and therefore may have lesser percentages in the composite and enable stronger interfacial interaction between graphene and the matrix of the polymer. In addition, low oxygen content of the graphene may provide improved interaction with non-polar (hydrophobic) polymer matrices.

The image of high-resolution transmission electron microscopy (HRTEM) of a representative sheet of joule heated graphene in FIG. 1C demonstrates the turbostratic nature of the graphene. The sheet structure in the center of the image has dimensions which are approximately 500×700 nm and is composed of a few stacked layers of graphene. Inset shows a high magnification image of the sheet edge displaying three graphene planes. Wrinkles 140 and ripples 145 are observed on the edges of the central structure, characteristic of bi-dimensional materials.

The SAED in FIG. 1D shows the turbostratic characteristics of the central sheet, where it is possible to observe multiple distinct bright spots within a 60° arc 120. The arc 120 is visually shown using a curved arrow between two white lines which define the beginning and end of the arc. Each bright spot results from the electron diffraction of one graphene layer or a few graphene layers with the same orientation. The angular orientation of selected bright spots was calculated relative to one arbitrary spot selected as 0° (located at the right of the 60° arc 120) to demonstrate the turbostratic nature of the graphene sheet in image FIG. 1C (Gupta et al., Twist-Dependent Raman and Electron Diffraction Correlations in Twisted Multilayer Graphene, J. Phys. Chem. Lett., 2020, 11, 8, 2797-2803).

Referring to FIG. 1F, illustrated therein is a X-ray photoelectron spectroscopy (XPS) spectra of the sample of turbostratic graphene from FIG. 1C produced by joule heating of a pill, according to an embodiment. The top graph 150 shows a survey scan, and the bottom graph 155 shows a carbon-edge high resolution scan and attribution.

The XPS shows the high purity of the turbostratic graphene and the low content of oxygen. The survey scan 150 shows a turbostratic graphene sample composed with more than 98% of carbon (atomic proportion). Other detected elements include oxygen and sulfur, although in low amounts (1.2% and 0.4%, respectively). The low content of oxygen is characteristic of the joule heating process and considerably lower compared to chemical methods of producing graphene by graphite exfoliation (>10%, atomic proportion, also measured by XPS) (Al-Gaashaniab et al., XPS and structural studies of high quality graphene oxide and reduced graphene oxide prepared by different chemical oxidation methods, Ceramics International, 2019, 45, 11, 14439-1444). The high-resolution spectra 155 on the carbon edge shows the carbon peak deconvoluted in four main peaks which are corroborated by a similar analysis of carbon materials in the literature (Lesiak et al., C sp²/sp³ hybridisations in carbon nanomaterials—XPS and (X)AES study, Applied Surface Science, 2018, 452, 223-231). The most prominent peak is located at 284.45 eV (˜80% of the carbon atoms) and is attributed to carbon atoms with an sp² hybridization (C═C). Other peaks indicate carbon with an spa hybridization and presence of C—O bonds (C—OH and C═O). The high content of sp² hybridization (nearly 80%) indicate most carbon atoms in the sample are arranged as 2D structures.

The high purity of graphene and low oxygen content of the present disclosure provides that a composite that is made with the turbostratic graphene has less defects and impurities and therefore requires lesser percentages in the composite to make the composite perform better than conventional composites.

Conventional production of turbostratic graphene grown via chemical vapor deposition (CVD) and other atomic deposition methods are slow and may not be able to produce more than few layers of graphene on a substrate, therefore the large quantity yields necessary for production of turbostratic graphene composites were not possible by previous methods. An advantage of the turbostratic graphene produced by joule heating is that the graphene is produced in large quantities, such as grams to kilograms in powder form. The high yields allow turbostratic graphene produced by joule heating to be used with composites.

Turbostratic graphene may be used as additive to make a polyurethane foam composite by adding between 0.01% to 5% by weight of turbostratic graphene to the polyurethane foam components, such as either the polyol or the isocyanate, before mixing of the polyurethane foam components. The examples herein demonstrate use 0.063% by weight of turbostratic graphene in the foam materials, however, any concentration between 0.01° A to 5% by weight turbostratic graphene may be used.

Provided is a turbostratic graphene polyurethane foam which provides various advantages over polyurethane foam having a graphite nano-platelet (GNP) material, an A-B stacked graphene, and carbon nanoparticles.

In an embodiment, the turbostratic graphene may possess a larger surface area of 200 m²/g to 300 m²/g compared to 120 m²/g to 150 m²/g of conventional graphene.

In an embodiment, the turbostratic graphene may have a particle diameter between 5 nm to 200 nm if produced from a carbon black feedstock or between 100 nm to more than 2000 nm if sourced from a Petroleum Coke or coffee grounds. In comparison, conventional turbostratic graphene possesses a particle diameter between 4 to 6 microns.

In an embodiment, a dispersion of turbostratic graphene may have a concentration between 1 mg/mL(1 g/L) to 15 mg/mL (15 g/L). In comparison, conventional graphene dispersions may only have a concentration up to 1 mg/mL (1 g/L).

In an embodiment, the turbostratic graphene may have a low content of oxygen between 0.1% to 5% by atomic proportion. In comparison, conventional graphene typically possesses a higher oxygen content of 10% or greater by atomic proportion. If desired, the oxygen content of the turbostratic graphene may be increased by intentionally introducing oxygen content after generating the turbostratic graphene.

In an embodiment, turbostratic graphene concentrations in the turbostratic graphene polyurethane foam may be between 0.01° A to 5% by weight. The improved dispersion properties and fewer number of graphene layers of turbostratic graphene allows for increased concentrations of graphene in the polyurethane foam and the turbostratic graphene polyurethane foam therefore has a lower weight per unit volume compared to polyurethane foam with traditional graphene.

### EXAMPLE 1

### Polyurethane Foam Fabrication

Provided herein is a polyurethane foam (PUF) containing turbostratic graphene which is fabricated and tested. One method of making a turbostratic graphene is via resistive (ohmic) joule heating, thereafter called joule heated graphene. The results are compared to PUF made with no additive, with a carbon black (CB) additive, and with conventional graphene. The turbostratic graphene based PUF had better mechanical properties than PUF with no additives or PUF with other types of graphene.

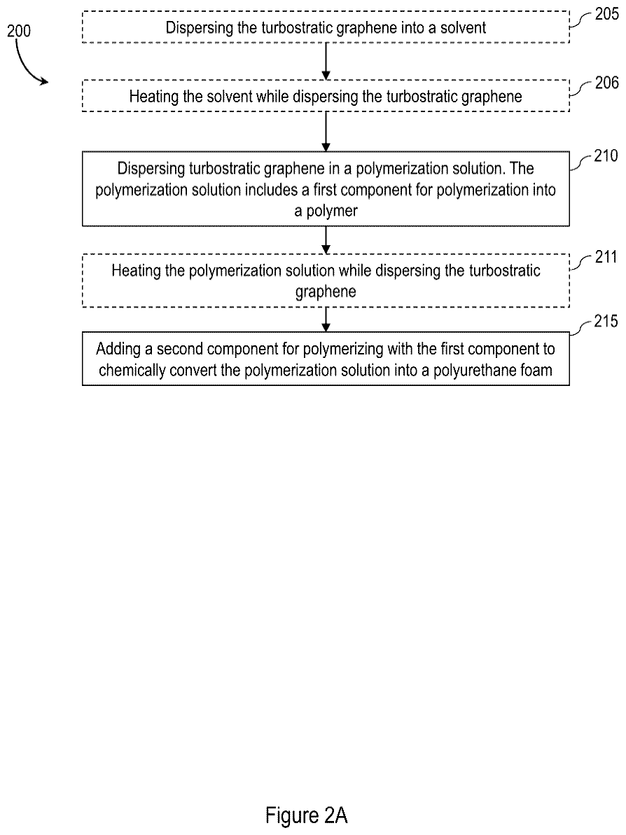

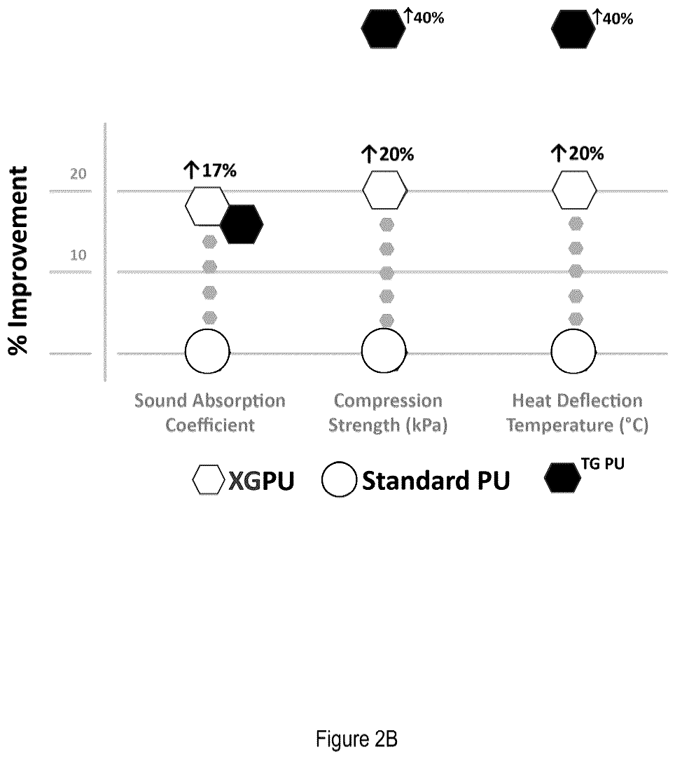

Referring to FIG. 2A, illustrated therein is a flowchart demonstrating a method 200 of producing a polyurethane foam, in accordance with an embodiment. The method 200 includes dispersing turbostratic graphene in a polymerization solution, at 210. Optionally, the method 200 includes heating the polymerization solution while dispersing the turbostratic graphene, at 211. The polymerization solution includes a first component for polymerization into a polymer. The method 200 also includes adding a second component for polymerizing with the first component to chemically convert the polymerization solution into a polyurethane foam, at 215. Optionally, the method 200 includes dispersing the turbostratic graphene into a solvent, at 205, prior to dispersing the turbostratic graphene in a polymerization solution, at 210. Optionally, the method 200 includes heating the solvent while dispersing the turbostratic graphene, at 206.

In some embodiments, the first component is a polyol and the second component is an isocyanate. In some embodiments, the first component is an isocyanate and the second component is a polyol. The polymerization solution is a solution that is capable of being converted into a polyurethane foam. In some embodiments, the first component is a monomer or a polymer. In some embodiments, the second component is a monomer or a polymer.

Referring to FIG. 2B, illustrated therein is a comparison of the physical properties of turbostratic graphene based PUF composite (TGPU) to a PUF composite having conventional graphene (XGPU). The increase in physical properties are shown relative to PUF without any additives (Standard PU).

In an embodiment, a commercial Flex Foam-iT! Polyurethane Foam kit may be used for producing a PUF. The kit contains two parts, Part A is a Methylene diphenyl diisocyanate (MDI) based isocyanate material, while Part B is a polyol material. Typically, the material in Part B is a petroleum-based polyol but it may also be a bio-based polyol or a combination of a petroleum-based and bio-based polyols.

One example of a turbostratic graphene PUF (PUF/TG) fabrication is described as Batch H. The turbostratic graphene is produced from a carbon feedstock that was 30% bark+70% petroleum-coke, prepared in the form of a compressed carbon-based pill, and joule heated to convert the carbon into turbostratic graphene. 20 mg of turbostratic graphene is mixed with 20 g of Part B polyol (0.1%) by first heating the polyol at 80-100° C., until the polyol solution becomes less viscous, then adding the 20 mg of turbostratic graphene, followed by ultrasonication of the mix until the mix becomes uniformly black. In the next step, 11.5 g of Part A is mixed with the dispersion of Part B with turbostratic graphene for 15-30 seconds and poured into a mold, where it is cured for 2 hours at room temperature. The amount of turbostratic graphene in the PUF/TG that is produced is 0.063% by weight. A PUF with conventional graphene (PUF/XG) and PUF with carbon black (PUF/CB) is also made with the same method where the turbostratic graphene was replaced with conventional graphene and with carbon black, respectively.

Another example of a PUF fabrication is described as Batch R. The turbostratic graphene is produced from a carbon feedstock that is 30% bark+70% petroleum-coke, prepared in the form of a compressed carbon-based powder, and joule heated to convert the carbon into turbostratic graphene. 20 mg of turbostratic graphene is first dispersed with 20 ml of benzene and ultrasonicated until the turbostratic graphene is dispersed well. Then, the graphene/benzene slurry is dispersed with 11.5 g of Part A (the MDI) and is mixed using a magnetic stirring rod until the mix is uniformly black. In the next step, 20 g of Part B (polyol) is mixed with the dispersion of Part A with graphene/benzene for 15-20 seconds and then poured in a Pyrex mold, where it is cured for 2 hours at room temperature. The amount of turbostratic graphene in the PUF is 0.063%. The PU/XG and PU/CB foams are made with the same method where the turbostratic graphene is replaced with conventional graphene and with carbon black, respectively.

The turbostratic graphene may also be dispersed in toluene, N-methyl-2-pyrrolidone (NMP), or xylene instead in Benzene. Other liquid dispersers compatible with the Part A material (isocyanate-containing compound such as MDI) and with the Part B material (polyols) may also be used.

The physical characteristics of the foams made in example batch H are shown in Table 1.

TABLE 1
Physical properties of a TG/PUF with 0.063%
turbostratic graphene content compared to
PUF without an additive, CB/PUF, and XG/PUF.

| Additive carbon | | | | |
|---|---|---|---|---|
| ultrasonicated | PUF without | 0.063% | 0.063% | 0.063% |
| in MDI | additive | CB/PUF | XG/PUF | TG/PUF |
| Density (kg/m³) | 72.2 | 61.3 | 74.1 | 76.0 |
| Average Pore Size | 878 | 716 | 470 | 402 |
| (μm) | | | | |

As a reference, the density of the foam for automotive applications is 42 kg/m³ or greater, and the density for automotive seat cushions and backs should be in the range of 20-95 kg/m³.

The foam cell number increases and the foam cell size decreases as graphene-like material is added. The foam cell size of PUF with 50% petroleum and 50% bio-based polyols is in the range of 200-600 microns, while the foam cell size with a 1% graphite nano-platelet (GNP) additive is 200 microns or less.

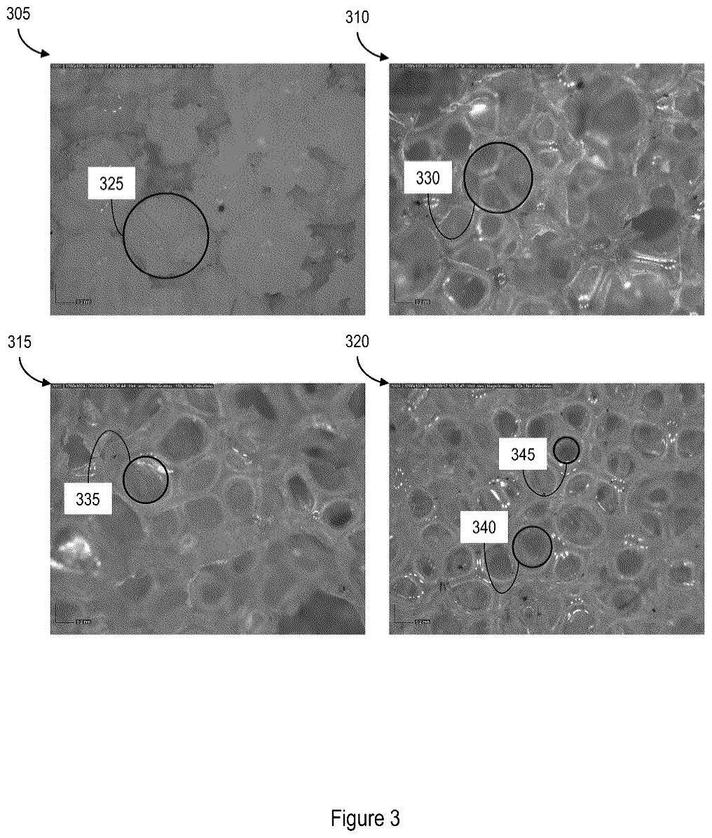

Referring to FIG. 3, illustrated therein are images of the foam pore sizes as a function of additive material, according to an embodiment. The pore sizes of PUF without any additives 305, PUF with 0.063% carbon black 310, PUF with 0.063% conventional graphene 315, and PUF with 0.063% turbostratic graphene 320 are shown. The circumference of a representative bubble 325 from the PUF without any additives 305 is 2.761 mm, the area is 0.606 mm², and the radius is 0.439 mm. The circumference of a representative bubble 330 from the PUF with 0.063% carbon black 310 is 2.251 mm, the area is 0.403 mm², and the radius is 0.358 mm. The circumference of a representative bubble 335 from the PUF with 0.063% conventional graphene 315 is 1.477 mm, the area is 0.174 mm², and the radius is 0.235 mm. The circumference of a first representative bubble 340 from the PUF with 0.063% turbostratic graphene 320 is 1.263 mm, the area is 0.127 mm², and the radius is 0.201 mm. The circumference of a second representative bubble 345 from the PUF with 0.063% turbostratic graphene 320 is 0.848 mm, the area is 0.057 mm², and the radius is 0.135 mm.

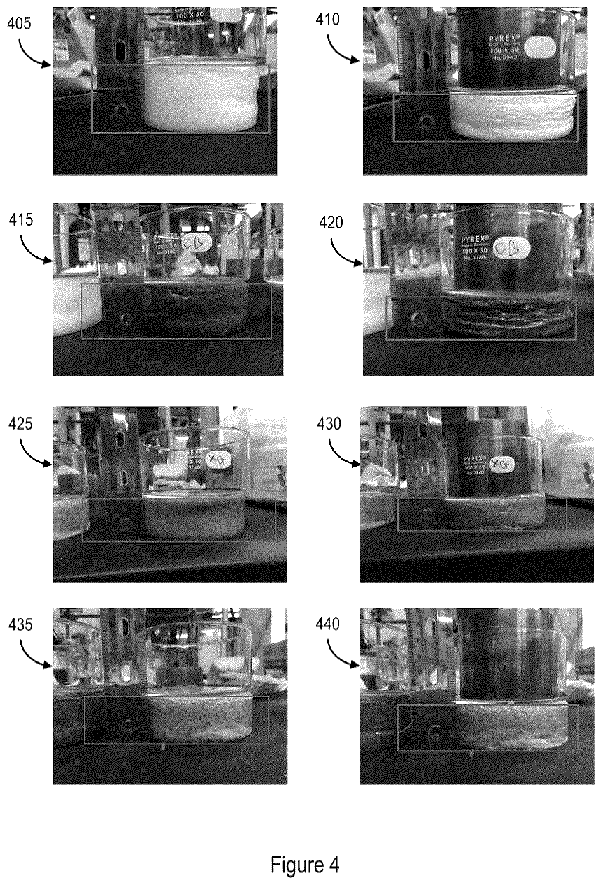

Referring to FIG. 4, illustrated therein are images polyurethane foams of Batch R are shown before and after compression with a 2 kg load, according to an embodiment. PUF without any additives is shown before 405 and after 410 compression. PUF with 0.063% carbon black is shown before 415 and after 420 compression. PUF with 0.063% conventional graphene is shown before 425 and after 430 compression. PUF with 0.063% turbostratic is shown before 435 and after 440 compression.

As shown in Table 2, the compressive strength of the four PUFs fabricated in example Batch R is measured, according to an embodiment. The thickness of each foam is measured and compared to the compressed thickness with a 2kg load. The compressive strength (kPa) and the relative compression strength between foams was computed from the measurements of the pre-load and compressed thickness of each foam.

TABLE 2
Compressive strength of PUFs of example Batch R.

| Additive carbon | | | | |
|---|---|---|---|---|
| ultrasonicated | PUF without | 0.063% | 0.063% | 0.063% |
| in MDI | additive | CB/PUF | XG/PUF | TG/PUF |
| Compressive Strength | 8.6 | 8.5 | 15.3 | 31.1 |
| (kPa) | | | | |
| Change (%) | 0.0 | −1.2 | 78.4 | 262.4 |

As shown in Table 2, the addition of turbostratic graphene to the PUF increases the compressive strength of the foam by 262%. The conventional graphene increases the compression by 78%.

As shown in Table 3, the compressive strength of the four PUFs fabricated in example Batch H is measured, according to an embodiment. The thickness of each foam is measured and compared to the compressed thickness with a small mass load of 100 g. The compressive strength (kPa) and the relative compression strength between foams was computed from the measurements of the pre-load and compressed thickness of each foam.

TABLE 3
Compressive strength of PUFs of example Batch H.

| Additive carbon | | | | |
|---|---|---|---|---|
| ultrasonicated | PUF without | 0.063% | 0.063% | 0.063% |
| in MDI | additive | CB/PUF | XG/PUF | TG/PUF |
| Compressive Strength | 8.5 | 8.2 | 9.3 | 12.2 |
| (kPa) | | | | |
| Change (%) | 0.0 | −3.5 | 9.4 | 43.5 |

As shown in Table 3, the addition of turbostratic graphene contributes to a more that 40% change in compressive strength which is much more than conventional graphene.

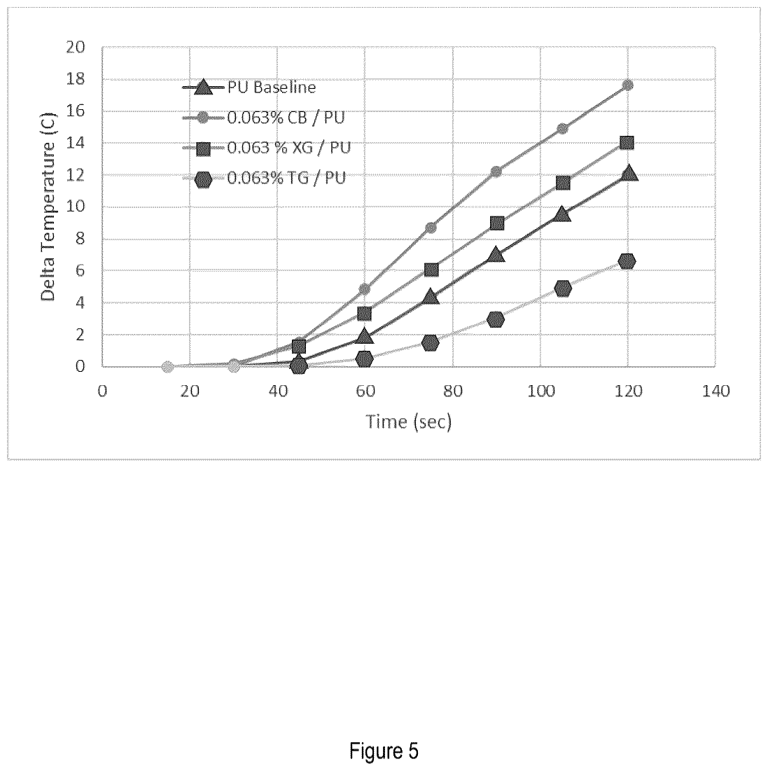

Referring to FIG. 5, illustrated therein is a graph showing the thermal conductivity of the four polyurethane foams, according to an embodiment. The thermal conductivity of the four PUFs is measured by placing them on a hot plate that is set to 100° C. The thermocouple probe is inserted 1 cm from the bottom of each foam to avoid the issue if each foam has a slightly different thickness. The foam temperature is recorded each 15 seconds for 2 minutes.

As shown in Table 4, the change in temperature (dT) after 2 minutes of heating the PUFs at 100° C. is measured, according to an embodiment.

TABLE 4
Thermal conductivity of PUFs of example Batch R.

| Additive carbon | | | | |
|---|---|---|---|---|
| ultrasonicated | PUF without | 0.063% | 0.063% | 0.063% |
| in MDI | additive | CB/PUF | XG/PUF | TG/PUF |
| dT after 2 min at | 13.7 | 19.3 | 16.7 | 8.5 |
| To = 100° C. | | | | |
| Change (%) | 0.0 | −29.0 | −18.0 | 61.2 |

The addition of turbostratic graphene increases the thermal insulation of the foam by 61% as compared to the baseline PUF without an additive. In contrast, the conventional graphene and carbon black increases the thermal conductivity.

The amount of the turbostratic graphene in the PUF may be increased or decreased to use the loading effect to alter the thermal conductivity of the PUF.

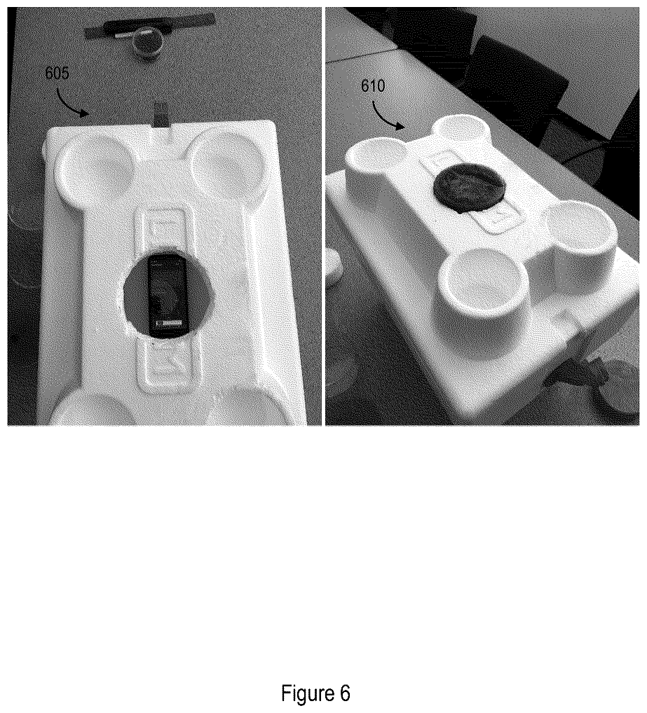

Referring to FIG. 6, illustrated therein are images of an apparatus for measuring the sound absorption characteristics of the four polyurethane foams, according to an embodiment. The sound absorption characteristics of the four PUFs is measured with a styrofoam box, where a device, such as a smartphone, is placed inside the box to generate sound with 3 specific frequencies within the useful range for the automotive industry, 1600 Hz, 2000 Hz and 2500 Hz, as shown at 605. The samples of the PUF are placed in an opening on the lid of the box as shown at 610, and second device, such as a second smartphone, is placed on top of the PUF. The second smartphone has sound analysis software that was recording sound dBs.

The sound absorption properties of the PUFs are shown in Table 5.

TABLE 5
Sound absorption of PUFs of example Batch R.

| Additive carbon | | | | |
|---|---|---|---|---|
| ultrasonicated | PUF without | 0.063% | 0.063% | 0.063% |
| in MDI | additive | CB/PUF | XG/PUF | TG/PUF |
| 1.6 kHz (% sound | 0 | −10 | −30 | −35 |
| absorption | | | | |
| improvement) | | | | |
| 2.0 kHz (% sound | 0 | 0 | 44 | 44 |
| absorption | | | | |
| improvement) | | | | |
| 2.5 kHz (% sound | 0 | 13 | 31 | 13 |
| absorption | | | | |
| improvement) | | | | |

The sound absorption quality of the PUF is highly dependent on the frequency of the sound but it is improved as carbon-based additive is added. The PUF with 0.063% turbostratic graphene content attenuated the sound for frequencies above 2 kHz. Acoustically, turbostratic graphene was even compared to conventional graphene based foam.

### EXAMPLE 2

### Turbostratic Graphene Dispersions

In an embodiment, turbostratic graphene is first dispersed in a liquid to break the weak surface forces that hold the graphene powder together. The turbostratic graphene dispersion may be used for further dilution with a variety of materials typically used in making a PUF and for making master batches, such as polyol and isocyanate-containing compound. Due to the turbostratic nature of the graphene the turbostratic graphene particles, ranging in size from 5 nm to 2000 nm, disperse with low energy and stay separated and do not agglomerate even after days or years. The turbostratic graphene-liquid dispersion does not agglomerate when diluted or further mixed with other materials typically used in making polyurethane foam and after making a master batch such as a polyol masterbatch or an isocyanate-containing masterbatch.

In general, turbostratic graphene dispersions are 4× higher in concentration than the most concentrated conventional graphene dispersions produced by conventional liquid phase exfoliation of graphite, and greater than 10 times higher concentrations than many reported values of graphene nanoplatelets (GNPs).

The turbostratic graphene dispersion in water, alcohol, solvent, or oil may be achieved with an ultrasonication equipment or with shear mixer. For example, a turbostratic graphene-water dispersion may be achieved by ultrasonication for 2 to 30 minutes, or shear mixing for 15 minutes at 4000 rpm to 5000 rpm.

In an embodiment, turbostratic graphene may be dispersed at various concentrations (1-5 mg/mL or 0.5% w/w in water) in 1% water-pluronic (F-127) solution. Other common water compatible surfactants may also be used instead of pluronic F-127, such as common kitchen dishwashing liquid, Dihydrolevoglucosenone (Cyrene), and other common water compatible surfactants. Other water compatible surfactant/dispersant systems for graphene dispersion include: Sodium dodecyl sulfate (SDS), Sodium dodecylbenzenesulfonate (SDBS), Lithium dodecyl sulfate (LDS), Sodium deoxycholate (DOC), Sodium taurodeoxycholate (TDOC), Cetyltrimethylammonium bromide (CTAB), Tetradecyltrimethylammonium bromide (TTAB), Pluronic F87, Polyvinylpyrrolidone (PVP), Polyoxyethylene (40) nonylphenylether (CO-890), Triton X-100, Tween 20, Tween 80, Polycarboylate (H14N), Sodium cholate, Tetracyanoquinodimethane (TCNQ), Pyridinium tribromide, N,N′-dimethyl-2,9-diazaperopyrenium dication, N,N′-dimethyl-2,7-diazapyrene, Tetrasodium 1,3,6,8-pyrenetetrasulfonate, 1-pyrenemethylamine hydrochloride, 1,3,6,8-pyrenetetrasulfonic acid tetrasodium salt hydrate, 1-pyrenecarboxylic acid, 1-aminopyrene, 1-aminomethyl pyrene, 1-pyrenecarboxylic acid, 1-pyrenebutyric acid, 1-pyrenebutanol, 1-pyrenesulfonic acid hydrate, 1-pyrenesulfonic acid sodium salt, 1,3,6,8-pyrenetetrasulfonic tetra acid tetra sodium salt, 6,8-dihydroxy-1,3-pyrenedisulfonic acid disodium salt, 8-hydroxypyrene-1,3,6-trisulfonic acid trisodium salt, Perylenebisimide bolaamphiphile, Tetrabutyl ammonium hydroxide (TBA), 9-Anthracene carboxylic acid.

In an embodiment, turbostratic graphene may be dispersed at various concentrations (1-50 mg/ml or 6.3% w/w in alcohols) in alcohols, including, without limitation, methanol ethyl alcohol, isopropyl alcohol, butanol, pentanol, ethylene glycol, propylene glycol, glycerol, and any combination thereof.

In an embodiment, turbostratic graphene may be dispersed at various concentrations (1-100 mg/ml or 11% w/w in organic solvent) in organic solvents, including, without limitation, acetone, toluene, N-methyl-2-pyrrolidone (NMP), xylene, benzene, 1,2-dichlorobenzene (DCB), dimethylformamide (DMF), and methyl ethyl ketone (MEK).

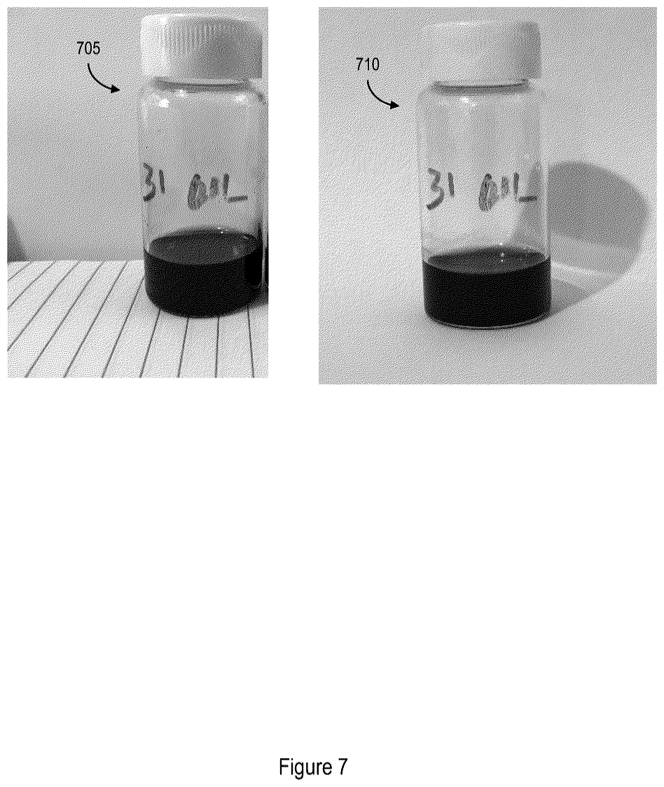

Referring to FIG. 7, illustrated therein is a turbostratic graphene-oil dispersion before 705 and after 710 three weeks of storage, according to an embodiment. The turbostratic graphene dispersion is maintained over the period of storage in olive oil.

In an embodiment, turbostratic graphene may be dispersed at various concentrations (1-100 mg/ml or 11% w/w in oils) in petroleum based oils and in vegetable based oils such as seed oils, soy bean oil, rapeseed oil, canola oil, peanut oil, cotton seed oil, sunflower oil, olive oil, grape seed oil, linseed oil, castor oil, fish oils, algal oils, mustard seed oils, and combinations thereof. Other oils may include mineral oil, paraffinic oil, and naphthenic oil.

In an embodiment, turbostratic graphene dispersion may be on water, alcohol, solvent, or oil. The turbostratic graphene dispersion may be used to make a master batch such as isocyanate-containing masterbatch and polyol masterbatch. The turbostratic graphene dispersion is sheer mixed with an isocyanate-containing material or polyol material to make a masterbatch. Because of the dispersion capabilities of the turbostratic graphene, the masterbatch, may be at least 5× diluted with respect to the batch. In another embodiment, the turbostratic graphene dispersion may be further concentrated by evaporating part of the dispersant by heating, distillation, centrifugal separation, or by chemical means.

In an embodiment, turbostratic graphene is used to make a master batch such as isocyanate-containing masterbatch and polyol masterbatch by directly dispersing the turbostratic graphene into the isocyanate or polyol material. Optionally, the direct dispersion the isocyanate or the polyol are kept at room temperature. Optionally, the isocyanate or the polyol are heated (80° C. to 100° C.) until the desired viscosity is achieved to effectively disperse the turbostratic graphene.

In some embodiments, the isocyanate may include, without limitation, methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), tolidine diisocyanate (TODD, and combinations thereof.

In some embodiments, the polyol materials may include petroleum-based polyols and bio-based polyols and combinations thereof.

The addition of turbostratic graphene to PUF provides advantages that are not present if the PUF additive material is GNP. Because of the poor dispersion characteristics of GNPs, GNPs tends to agglomerate and increase the medium viscosity. These attributes make it difficult to disperse GNP into a polymer matrix without sacrificing the performance characteristics of the polymer matrix. In addition, the increased viscosity makes it harder to pump out the polyol and the isocyanate from the holding tanks to the dispersing nozzle.

Due to the turbostratic nature of the turbostratic graphene, the turbostratic graphene may advantageously be able to disperse better than other types of conventional graphene, so the individual graphene grains will not agglomerate for days or months. These attributes may advantageously make it easy to disperse turbostratic graphene into a polymer matrix and improve the performance characteristics of the polymer matrix. In addition, the viscosity of the turbostratic graphene-polyol dispersion and the turbostratic graphene-isocyanate dispersion may advantageously make it easy to pump out the turbostratic graphene-polyol dispersion and the turbostratic graphene-isocyanate dispersion from the holding tanks to the dispersing nozzle.

In an embodiment, flexible polyurethane foams may be prepared following a one-shot method. This procedure includes mixing of the turbostratic graphene dispersion, such as turbostratic graphene-toluene, with an isocyanate, such as MDI, at 1,000 to 1,500 rpm for 1-5 minutes, to make turbostratic graphene-MDI mixture. Optionally, the turbostratic graphene may be dispersed in the surfactant. Optionally, the turbostratic graphene may be dispersed in the water which is a blowing agent. Optionally, if the disperser, water, alcohol, oil, or solvent is not desirable in the final foam product, the turbostratic graphene dispersion may be treated to remove the disperser via thermal heating, distilling, or through chemical methods. In one example the turbostratic graphene concentration is 0.05% of the total weight of the polyols and MDI and the TG is introduced via toluene dispersion. In an example the turbostratic graphene concentration is 0.02% of the total weight of the polyols, MDI, and other chemical agents and the turbostratic graphene is introduced via water dispersion, where the water is 4% of the total weight.

Next, the turbostratic graphene-MDI is mixed with surfactant, catalysts, crosslinking and blowing agents while stirring at 1,500 rpm for 10 seconds, when the petroleum-based polyols, bio-based polyols, or their combination, are added while stirring at 1,500 rpm for 10 seconds more. At the 20 second mark, the mixed liquid is poured into a pre-heated steel mold, heated to 60° C. to 80° C. prior to pouring the mixture. The PUF mixture is held in the mold for 1 to 5 min after it is demolded. After demolding, the foam can be cured in an oven at 60 to 80° C. for 1 to 2 hours.

Other examples of a PUF composite with turbostratic graphene is by using bio-based polyols. Bio-based polyols are typically products based on triglycerides such as castor oil or modified soybean oils often referred to as natural oil polyols (NOPs). They are finding use as a partial substitute for petroleum-based polyols in applications including home furnishings (stab stock applications), molded foam (typically automotive applications) and rigid foam applications (especially spray foam insulation). NOPs are typically derived by functionalizing the unsaturated fatty acids in the natural oil to introduce hydroxyl functionality. Some examples of NOPS include Emery 14060 and 14090 polyols.

The turbostratic graphene PUF compositie and the methods provided herein may be applied to commercially available foam making kits that provide Part A and Part B components. Some examples of this kit include the Flex Foam-iT! III, Flex Foam-iT! 7FR flexible foams by Smooth-On and Foam-iT! 10 Slow rigid foams by Smooth-On.

### EXAMPLE 3

### PUF Produced by a Polyol Masterbatch

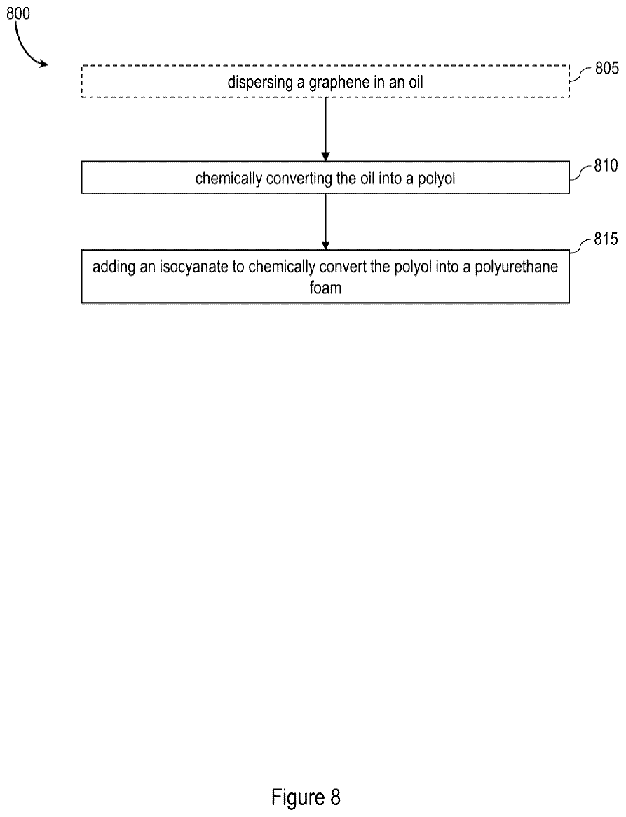

Referring to FIG. 8, illustrated therein is a flowchart demonstrating a method 800 of producing a polyurethane foam. The method 800 includes dispersing a graphene in an oil, at 805. The method also includes chemically converting the oil into a polyol, at 810. The method also includes adding an isocyanate to chemically convert the polyol into a polyurethane foam, at 815.

In an embodiment, a graphene is dispersed into a vegetable oil prior to chemically converting the graphene-oil dispersion into a polyol. The polyol that is produced is then used to produce a graphene PUF composite. Optionally turbostratic graphene may be used as the graphene of choice, but the graphene is not limited to turbostratic graphene. In this process the polyurethane foam is fabricated from isocyanate and the polyol where the graphene is pre-dispersed into the bio polyol.

Table 6 shows an example compositon of a bio polyol preparation from oil having dispersed graphene, according to an embodiment.

TABLE 6
Bio-based polyol composition from
a graphene-soybean oil dispersion.

| Component | Amount (grams) |
|---|---|
| Soybean oil | 309.60 |
| Turbostratic graphene | 0.31 |
| Iodine | 0.60 |
| Diethanolamine (DEA or DEOA) | 58.11 |
| Diphenylmethane diisocyanate (MDI) | 155.45 |

In the composition of Table 6, a turbostratic graphene is dispersed in the Soybean oil with concertation of 0.074% weight of the oil. The dispersion is ultrasonicated until a uniform black solution is obtained, typically in 2 to 15 minutes. The dispersion can also be mixed using a shear mixer tool. Next, the 58.11 g of diethanolamine and 0.60 g iodine are added to the above amount of turbostratic graphene-soybean oil dispersion with stirring. The mixture is stirred for 18 hours at between about 90° C. to about 113° C., then cooled to room temperature to give about 368.54 grams dark liquid TG-soy-polyol. The polyol is then reacted with the 155.45 g of diphenylmethane diisocyanate (MDI), where the turbostratic graphene concentration is 0.06% of the total weight, yielding a solid turbostratic graphene-soy polyurethane material.

Table 7 shows another embodiment of the oil-graphene dispersion for producing a polyol for conversion into a PUF, according to an embodiment.

TABLE 7
Bio-based polyol composition from a graphene-corn oil dispersion.

| Component | Amount (grams) |
|---|---|
| Corn oil | 309.60 |
| Turbostratic graphene | 0.31 |
| Hydrochloric acid (37%) | 10.0 |
| Diethanolamine (DEA or DEOA) | 58.11 |
| Diphenylmethane diisocyanate (MDI) | 155.45 |

In the composition of Table 7, a turbostratic graphene is dispersed in the corn oil with a concertation of 0.074% by weight of the oil. The hydrochloric acid is added to the turbostratic graphene-corn oil dispersion by stirring at room temperature. The mixture is heated to about 93° C. and is reacted for about one hour at about 93° C., followed by distillation to remove water under vacuum at about 93° C. The above indicated amount of diethanolamine is added to the mixture and stirred for 40 hours at between about 93° C. and about 112° C., then cooled to room temperature to give 368.54 grams dark liquid turbostratic graphene-corn oil polyol. The polyol is then reacted with the above disclosed amount of diphenylmethane diisocyanate (MDI), where the turbostratic graphene concentration is 0.06% of the total weight, yielding a solid TG-corn polyurethane material.

The turbostratic graphene PUF composites provided may be for automotive foams, but other foam applications may be implemented, including but not limited to bedding, furniture, flooring, and road fill and repair, and building construction. Other applications include urethane coatings, adhesives, sealants, epoxies, and elastomers. Other non-urethane applications may also be included, including cement and concrete making and asphalt making.

A bio-based polyol may provide advantages over a petroleum based polyol. For example, The bio-based polyol allows for the use of renewable resources instead of petroleum based non-renewable resources. Petroleum polyols generally also require more energy to produce than bio-based polyols.

While the above description provides examples of one or more apparatus, methods, or systems, it will be appreciated that other apparatus, methods, or systems may be within the scope of the claims as interpreted by one of skill in the art.

1. A method of producing a polyurethane foam, the method comprising:
dispersing turbostratic graphene in a polymerization solution, wherein the polymerization solution includes a first component for polymerization into a polymer; and
adding a second component for polymerizing with the first component to chemically convert the polymerization solution into a polyurethane foam.

2. The method of claim 1, wherein the first component is a monomer or a polymer.

3. The method of claim 1, wherein the second component is a monomer or a polymer.

4. (canceled)

5. The method of claim 1, wherein the first component is a polyol and the second component is an isocyanate.

6. The method of claim 5, wherein the polyol is at least one of the group comprising a petroleum-based polyol and a bio-based polyol.

7.-9. (canceled)

10. The method of claim 1 further comprising dispersing the turbostratic graphene into a solvent prior to dispersing into the polymerization solution.

11. The method of claim 10 further comprising heating the solvent while dispersing the turbostratic graphene into the solvent.

12. The method of claim 10 wherein the solvent includes at least one of the group comprising a water-based solvent, an alcohol-based solvent, an organic solvent, and an oil-based solvent.

13. The method of claim 12, wherein the water-based solvent is water-surfactant solution.

14.-24. (canceled)

25. The method of claim 1 further comprising heating the polymerization solution while dispersing the turbostratic graphene.

26. (canceled)

27. A polyurethane foam comprising:
a turbostratic graphene; and
a polymer formed from the polymerization of a polyol with an isocyanate.

28.-36. (canceled)

37. The polyurethane foam of claim 27, wherein the turbostratic graphene has a particle diameter between 5 nm to 2000 nm.

38. The polyurethane foam of claim 27, wherein the turbostratic graphene has an oxygen content of between 0.1% to 5% by atomic proportion.

39. (canceled)

40. The polyurethane foam of claim 27, wherein the turbostratic graphene is produced by joule heating a carbon powder.

41. (canceled)

42. The polyurethane foam of claim 27, wherein the turbostratic graphene is produced from a carbon feedstock by joule heating the carbon feedstock to a temperature between 2800° C. to 3000° C.

43.-44. (canceled)

45. Use of the polyurethane foam of claim 27 in an automotive seat, a bedding, a furniture, a flooring, a road fill, or building construction.

46. Use of the polyurethane foam of claim 27 as a urethane coating, an adhesive, a sealant, an epoxy, or an elastomer.

47.-53. (canceled)

54. A turbostratic graphene dispersion comprising:
a turbostratic graphene; and
a solvent for dispersing the turbostratic graphene.

55.-57. (canceled)

58. The turbostratic graphene dispersion of claim 54, wherein the solvent for dispersing the turbostratic graphene is a polyol solution for conversion into a polyurethane foam or an isocyanate solution for conversion into a polyurethane foam.

59. (canceled)

60. The turbostratic graphene dispersion of claim 54, wherein the solvent for dispersing the turbostratic graphene is at least one of the group comprising a water-based solvent, an alcohol-based solvent, an organic solvent, and an oil-based solvent.

61.-98. (canceled)
